(19) United States
(12) Patent Application Publication
(10) Pub. No.: US 2009/0313988 A1
(43) Pub. Date: Dec. 24, 2009

(54) Method of extracting energy from ocean waves

(76) Inventors: Jean Yves Cassagnol, Hempstead, NY (US); Andre Cassagnol, Boca Raton, FL (US)

Correspondence Address: Jean Yves Cassagnol, 20, Flint Ave., Hempstead, NY, 11550, US

(21) Appl. No.: 12/103,924

(22) Filed: Jun. 19, 2008

(51) Int. Cl. F03B 13/18; F03B 13/14

(52) U.S. Cl. 60/497; 60/506

(57) ABSTRACT

The purpose of this invention is to provide a reliable and efficient support to various methods of tapping from the free, and tremendous clean energy contained in ocean waves or any such waves, in the form of pressurized fluid, or linear and rotational motion, the most efficient way, the most economically, with the broadest scope possible, while taking into account the exigencies of marine environment, in three essential parts: 1—The hull of a floating carrier designed to pitch the most possible around a pivot shaft under the influence of the energy contained in the ocean waves. 2—A dependable pressure point, as a necessary element, where any force carried by the floating carrier hull will interact, to make available the tapped energy. 3—A mooring system that keeps the floating carrier hull free of any restriction or interference with other components, while positioning it for maximum pitching when subjected to the action of ocean waves.

A vessel is moored at sea in such a way as it pitches around a pivot axis when rocked by the energy contained in the passing waves.

A composed pendulum system, mounted on the same pivot shaft as the floating vessel is blocked by the combined effects of gravity and drag created by water over the pendulum.

The immobilized pendulum lever arm extension, supplying a counteractive force, is used as pressure points where the rods of a ram pumps system whose bases were attached to the rocking vessel hull are mounted.

When prompted, the setup delivers energy in the form of pressurized fluid, [oil, water, refrigerant], through smoothing accumulators, to hydraulic motors, turbines, refrigeration systems or desalination filters, as needed.

The pressurized fluid may be transformed into final use either on board of the vessel or transferred to another nearby vessel or platform or again to firm ground for treatment, via an umbilical cord

### BRIEF DESCRIPTION OF VIEWS AND ITEMS INCLUDED IN DRAWINGS

FIG. 1: clean side view of typical invention as it should appear as symbol

FIG. 1a: Side view of the “V bottom hull” version at the bottom of a sea wave.

FIG. 1b: Side view of the Flat “bottom hull” version, at the crest of a sea wave.

FIG. 1c: Side view of the “Round bottom hull” version, at the crest of a sea wave.

FIG. 2: Top view of the hull assembly equipped with its mooring fork and pendulum.

FIG. 3: Front view of the hull assembly equipped with its mooring fork and pendulum.

FIG. 4: Parts of the pivot system and counteractive pendulum disassembled.

FIG. 5: Assembled pivot system and counteractive pendulum.

FIG. 6: Cutaway view of counteractive pendulum mechanism interacting with piston pumps, vessel being at crest of wave.

FIG. 7: Cutaway view of counteractive pendulum mechanism interacting with piston pumps, vessel being rocked by incoming wave.

FIG. 8: Cutaway view of counteractive pendulum mechanism interacting with piston pumps, vessel being left by outgoing wave.

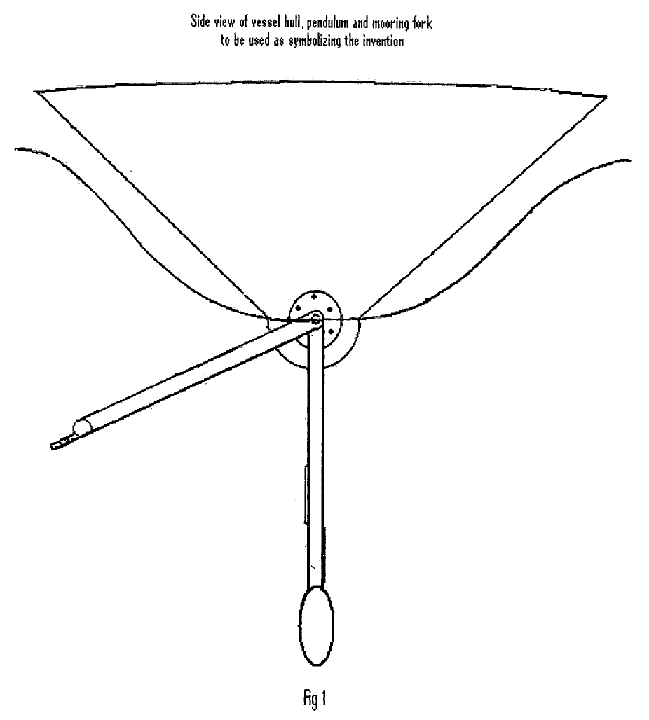

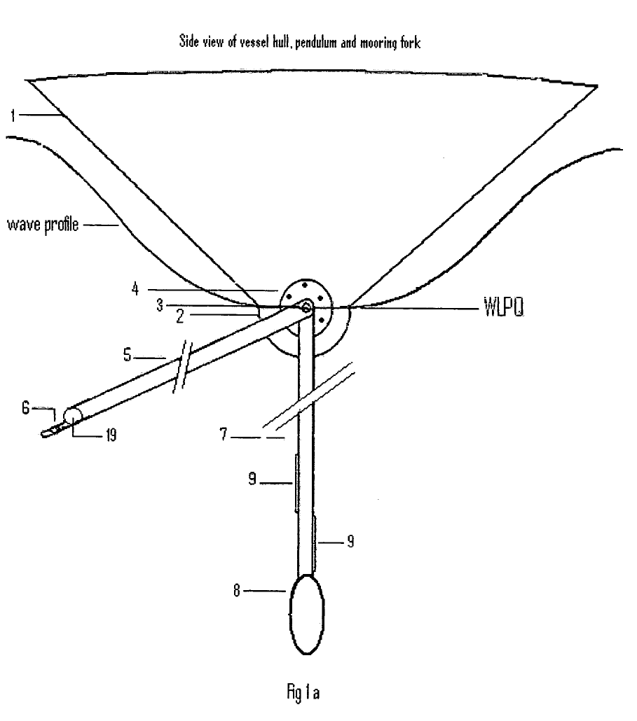

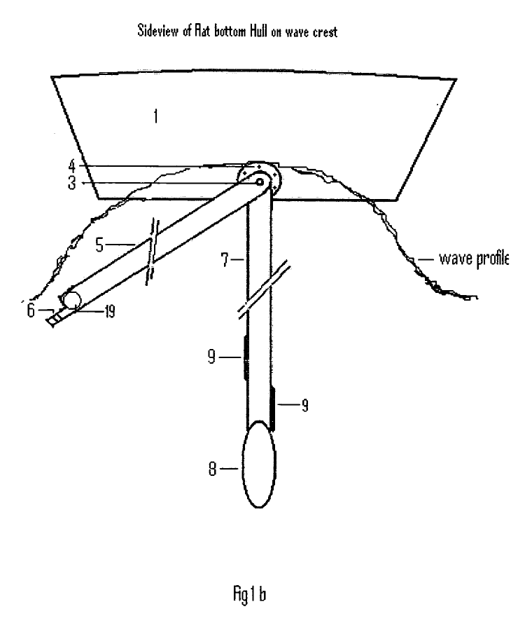

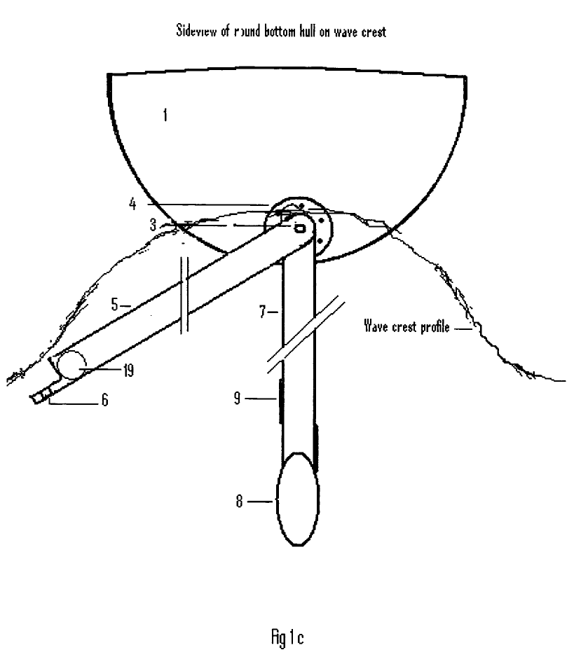

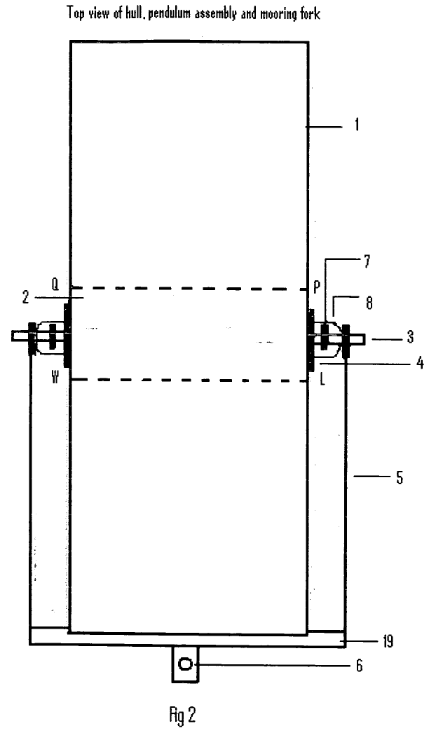

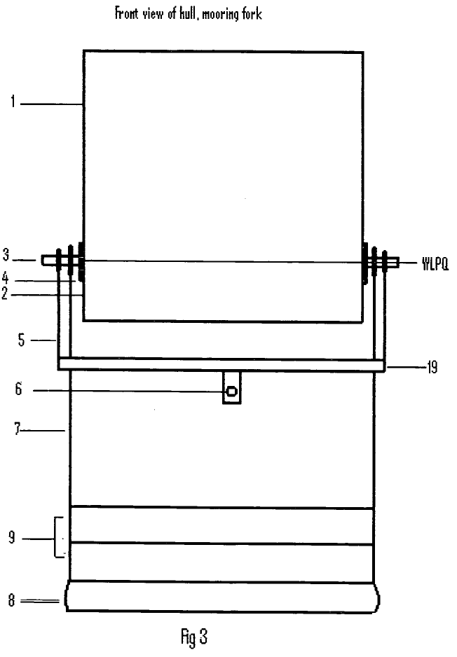

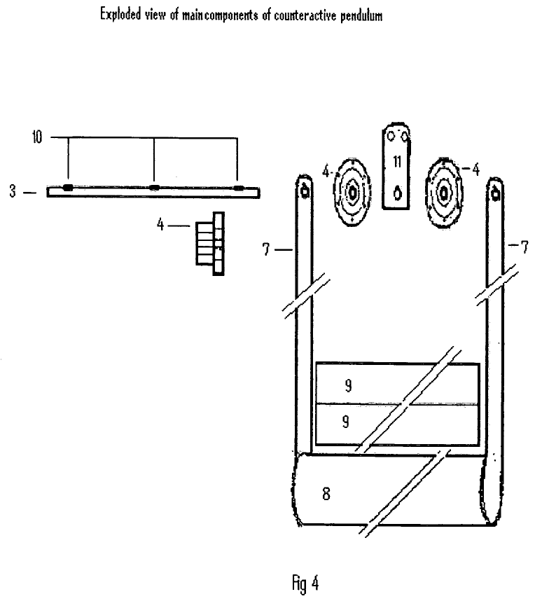

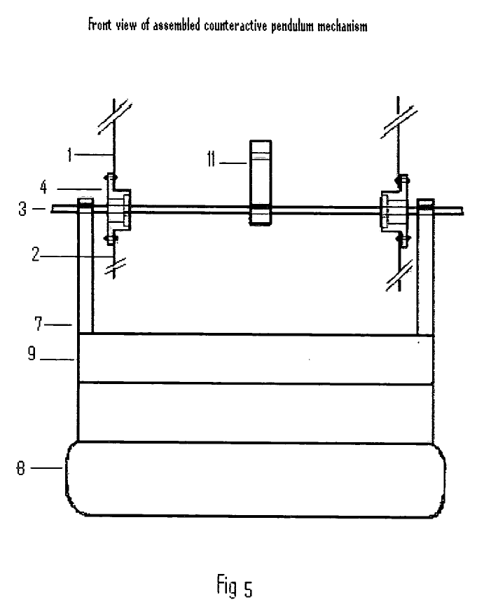

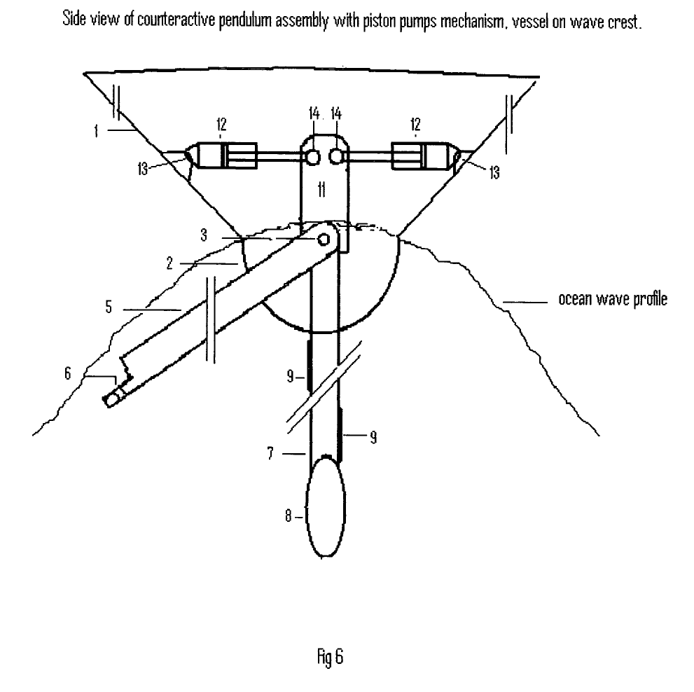

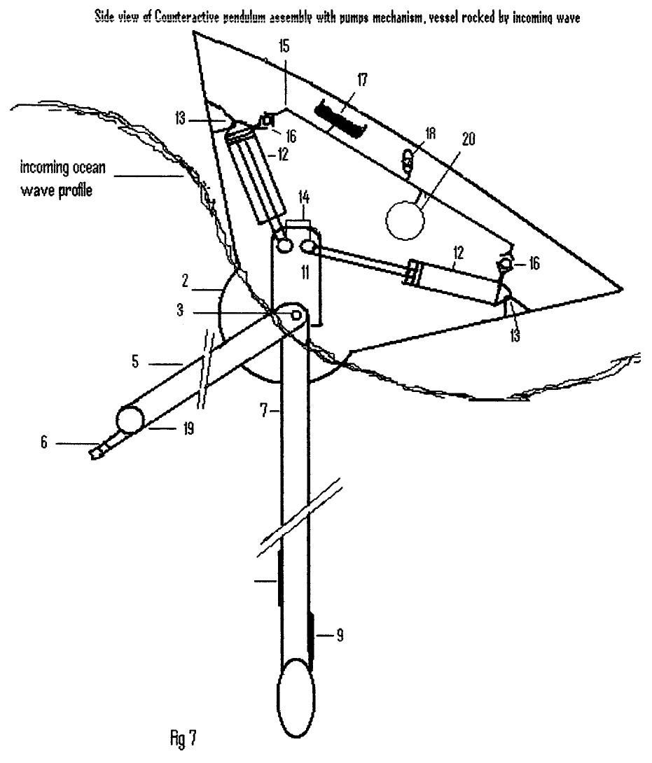

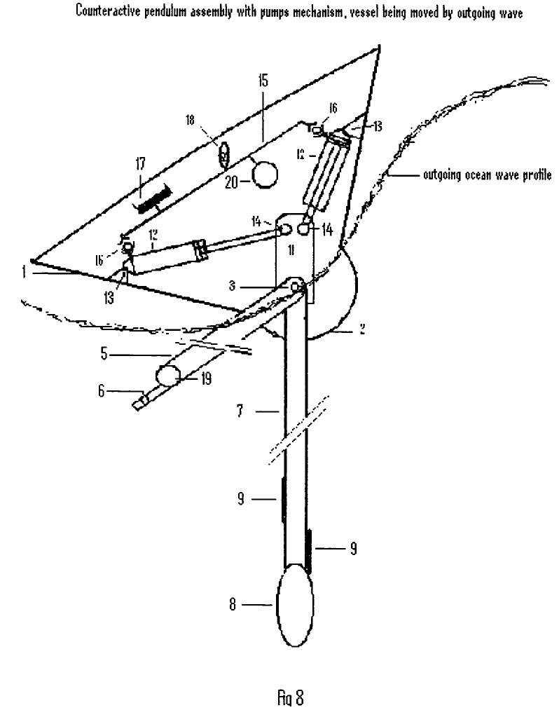

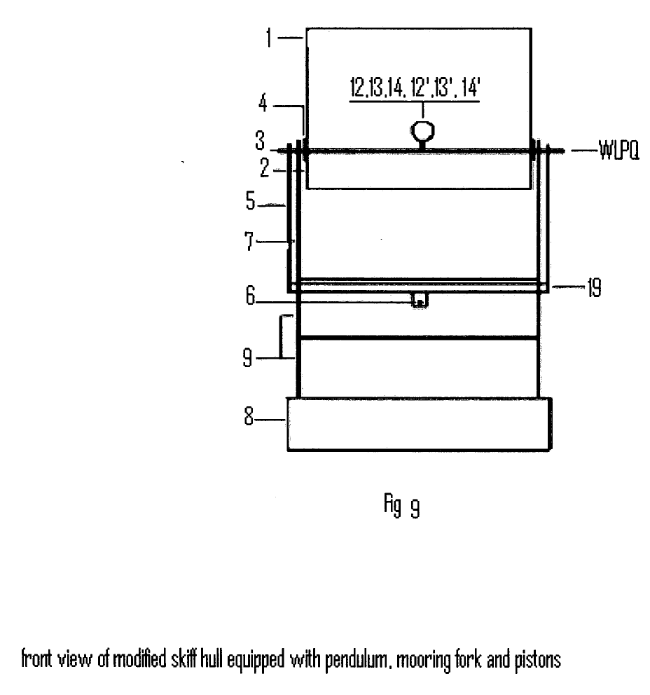

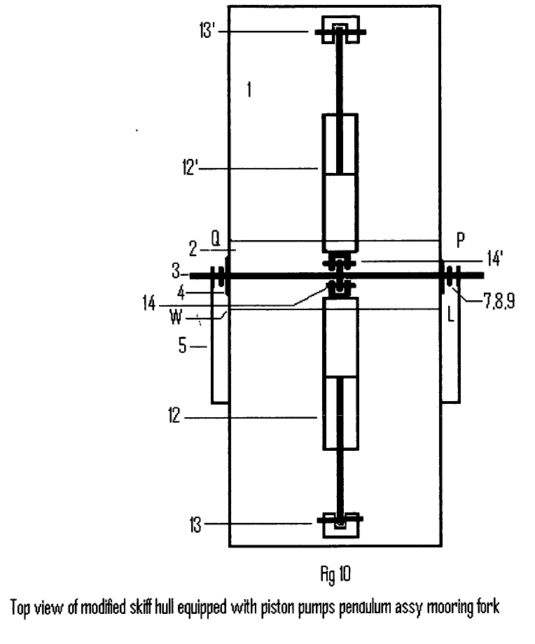

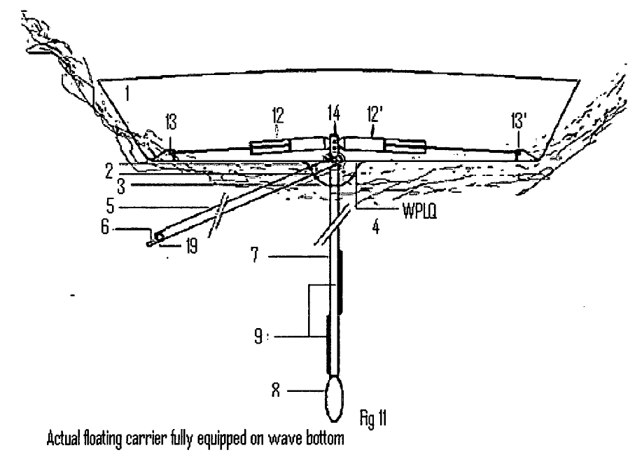

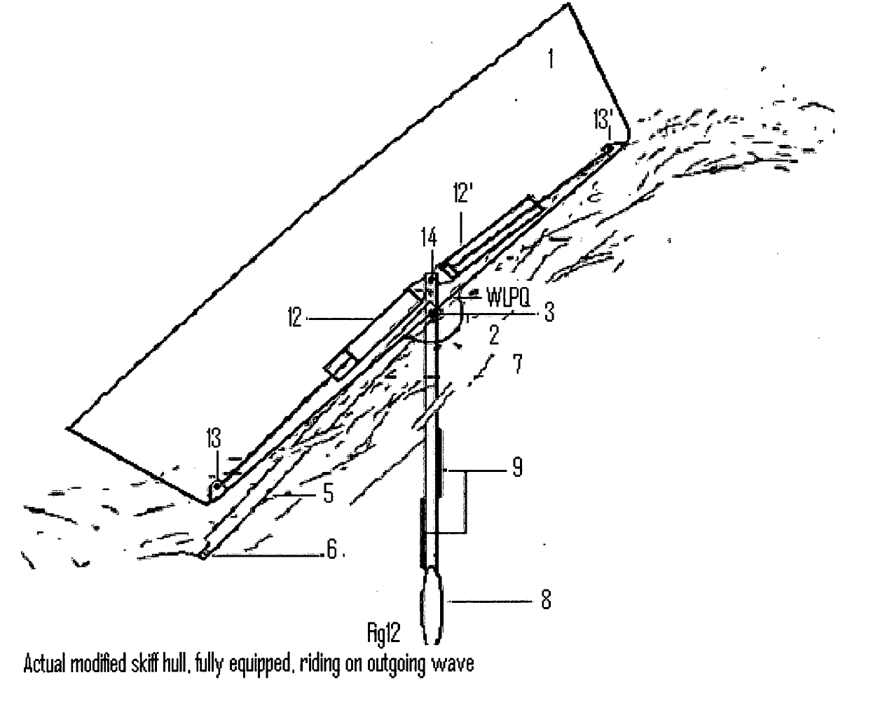

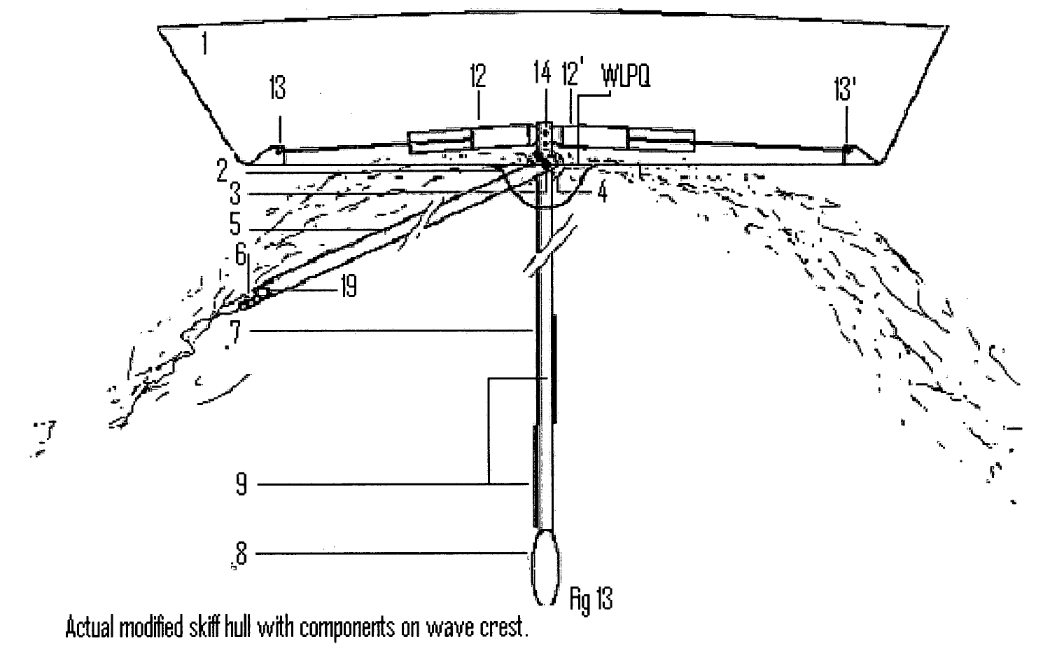

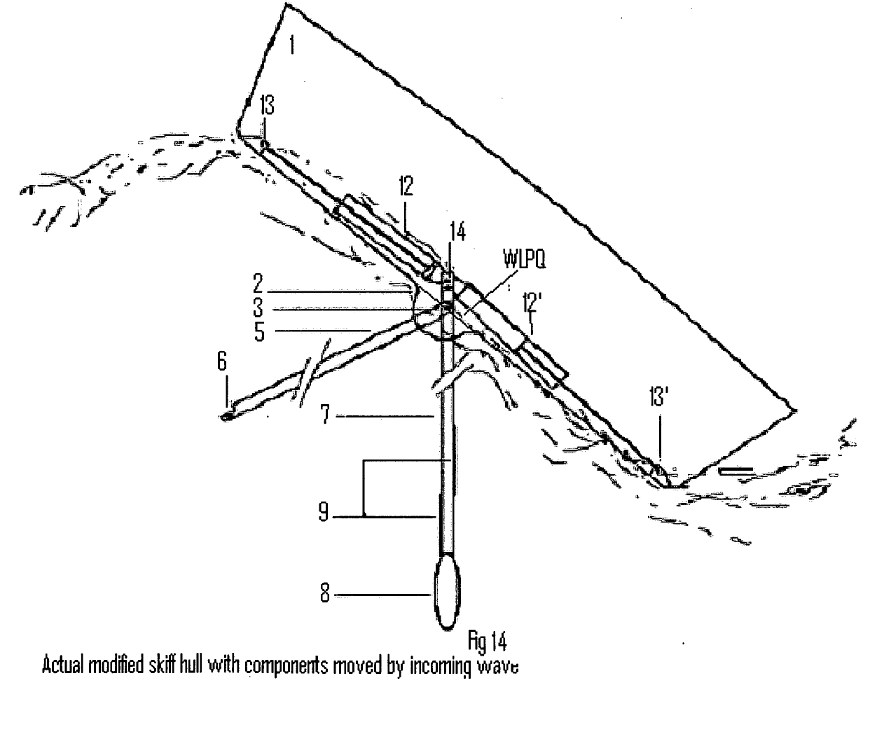

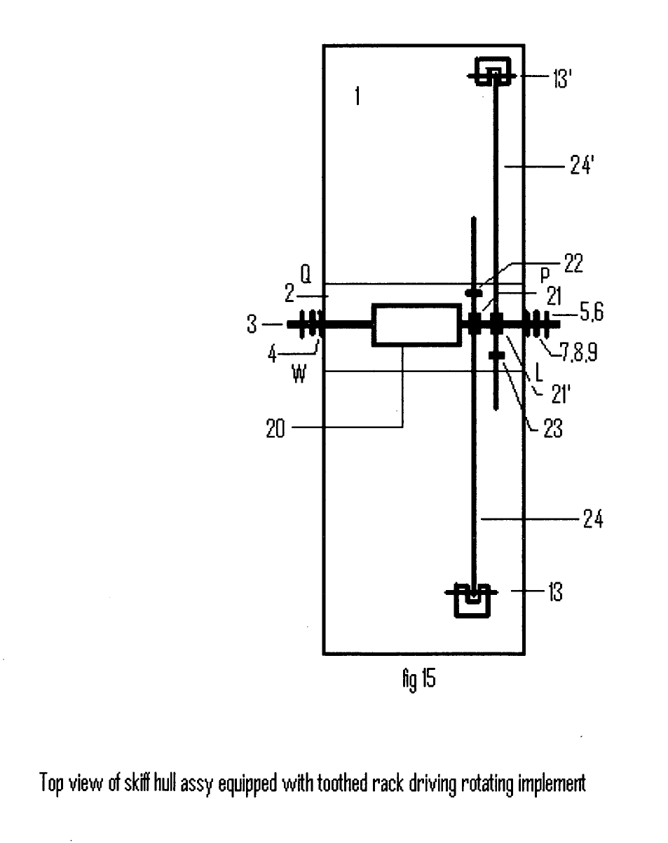

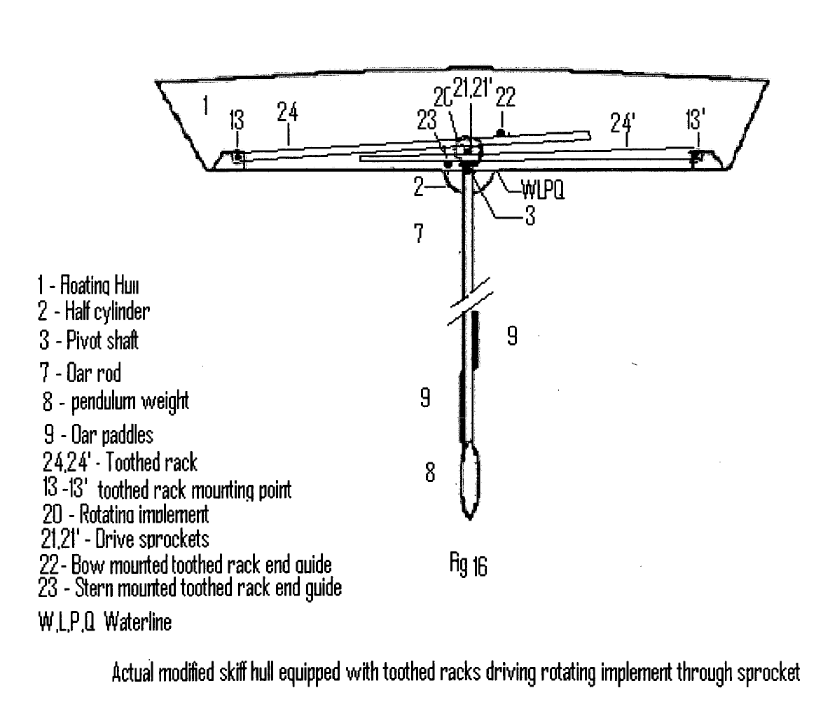

### ITEMS

1 Vessel hull freeboard
   WLPQ Waterline.
2 Half cylinder making submerged portion of hull
3 Pivot shaft for vessel and support for pendulum.
4 Bearing and seal block for shaft passing through vessel hull.
5 Mooring fork.
6 Mooring eyelet in mooring fork.
7 Pendulum lever arms
8 Weight of pendulum, mounted on both lever arms of pendulum.
9 Solid plates mounted on pendulum lever arms.
10 Keys binding pivot shaft and lever arm extension.
11 Lever arm extension.
12 Piston pumps.
13 Piston pumps mounting on vessel hull.
14 Piston pumps attached to lever arms extension.
15 Fluid lines feeding and discharging pumps.
16 Check valve system.
17 Fluid tank.
18. Smoothing accumulator
19 Mooring fork float.
20 Fluid motor or turbine.

1. The floating carrier
a—The overall shape of the floating carrier is that of the modified hull of a skiff.
The bow of the said floating carrier is identical to its stern so that any one may be used as the other.
The length of the hull of the said floating carrier is half or lesser the wavelength of the ocean wave where the floating carrier is operated.
The beam and the freeboard of the hull of the said floating carrier are determined by the scale of the projected unit.
b—At half the length of the bottom edge of the hull, on both sides of the said floating carrier, the horizontal pivot axle location is marked.
The said floating carrier hull will swing around the pivot axle when rocked by the energy contained in the passing waves.
c—A half-cylinder is centered around the bottom side of the pivot axle of the said floating carrier hull.
That half-cylinder replaces the hull bottom in that part of the said floating carrier.
That half-cylinder is such size as its sole volume is sufficient to float the total weight of the assembly: hull plus all internal and external components.
That half cylinder is the only submerged part of the said floating carrier.
d—The waterline of the equipped said floating carrier is technically the plane where this half-cylinder is bound to the flat bottom hull.
The center of gravity of the equipped said floating carrier will be maintained within the half-cylinder.

2. The counteractive oar or paddle.
a—In lieu of the pivot axle of the said floating carrier, we install a pivot shaft.
The ends of the pivot shaft extend beyond both sides of the said floating carrier hull.
The pivot shaft passes through the said floating carrier hull sides with proper bearing and sealing
b—Two pendulum lever arms are attached, one at each end of the pivot shaft of the said floating carrier,
c—One mass of pendulum is attached to both pendulum lever arms.
d—A paddle large enough is attached to both submerged lever arms to form a single oar with two arms.
This paddle and the mass are heavy enough to counterbalance all equipment carried by the pivot shaft.
e—While the said floating carrier hull pitches under the influence of the energy contained in the passing waves, gravity plus drag generated by water density maintain the submerged oar mass and arms in a vertical condition.
While the said floating carrier hull pitches under the influence of the energy contained in the passing waves, the pivot shaft remains immobile as attached to the oar arms.
f—Inside the said floating carrier hull, a vertical lever arm is attached to the pivot shaft, towards the top
This vertical lever arm constitutes a prolongation of the oar lever arms
This vertical lever arm follows the attached pivot shaft and the oar arms in their immobility.
This lever arm remains vertical, when the said floating carrier hull pitches under the influence of the energy contained in the passing waves.
Any point located on this lever arm is considered as a fix point in relation to any arching point of the rocking hull of the floating carrier.
f—The linear variation of the distance between a given point located on the said rocking floating carrier and a given point on the oar prolongation lever arm, other than the sole pivot axle point, is a reciprocal motion.
This reciprocal linear and varying motion comprised between the point on the rocking vessel hull and the fix point along the oar rod extension is suitable to energize directly any reciprocating mechanism such as: piston pumps, linear electric generators etc . . .
This reciprocal motion can be converted also into a unidirectional rotation motion by a toothed rack and sprockets set up.

3. The mooring
a—The common anchor deck-mooring system used in conventional boating has the inconvenience of restricting the up and down motion of a pitching boat bow.
At the same time, this procedure imposes stress on the mooring elements (bow, cleat and line) as well as on the anchor and the seabed.
The restriction of the up and down motion of the hull means also a waste from the energy available in the pitching hull.
b—The only mooring points of any anchored floating hull where this stress and that loss should be minimal are the pivot points located both sides the waterline mid-length of that boat.
These positions constitute the ideal mooring points for the floating carrier.
These points coincide with the location of the pivot axle of the floating carrier where we have previously fitted the pivot shaft.
d—In order to harness both pivot shaft ends simultaneously, we use a fork whose legs embrace each end of the pivot shaft.
These ends are simultaneously harnessed, in order to hold the floating carrier bow normal to the wave motion
The fork must swing around the ends of the pivot shaft of the said floating carrier.
This fork must be wide and long enough to leave the floating carrier bow and the pendulum mechanism move up and down between its legs.
The head of this fork is also where the anchor line of the floating carrier is tied.
This fork carries a flotation device that maintains its head at mid-water.
